(19) United States
(12) Patent Application Publication
(10) Pub. No.: US 2006/0199000 A1
(43) Pub. Date: Sep. 7, 2006

(54) Electrophotographic recording material

(76) Inventor: Naoyuki Ishii, Shizuoka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/366,559

(22) Filed: Mar. 3, 2006

(30) Foreign Application Priority Data
Mar. 3, 2005 (JP) 2005-059530

(51) Int. Cl. B32B 27/18

(52) U.S. Cl. 428/328; 428/411.1

(57) ABSTRACT

The present invention provides an electrophotographic recording material which attains improved levels of toner fixability, prevention of toner dispersion, prevention of unevenness in toner images, and excellent image density, as well as excellent toner image quality, high image transferrability, and high image density, and which exhibits improved sheet feeding performance in a printer. The electrophotographic recording material formed of a plastic support film, and a toner fixation layer provided on at least one surface of the plastic support film and containing a tin oxide, wherein the tin oxide is stannic oxide; the toner fixation layer has a surface resistivity A (Ω) of 1×10⁹ to 1×10¹⁴ Ω as measured at 23° C. and a relative humidity of 50%; and the recording material has a volume resistivity B (Ω·cm) as measured at 23° C. and a relative humidity of 50% which is controlled so that a ratio (B/A) falls within a range of 1×10² to 1×10⁵.

### BACKGROUND OF THE INVENTION

1. Field of the Invention

The present invention relates to an electrophotographic recording material and, more particularly, to an electrophotographic recording material which has mutually restricted correlation between surface resistivity of a toner fixation layer containing stannic oxide and volume resistivity of the recording material itself, and which is suitable for practical use.

2. Background Art

A variety of recording apparatuses including a laser beam printer and a copying machine employ an electrophotographic recording method, since the method can provide high-precision images at high printing speed without using a form plate. In recent years, electrophotographic recording method has been more widely employed, particularly in recording on transparent substrates such as stickers and transparent sheets for an overhead projector (OHP).

Conventionally employed electrophotographic recording materials are generally formed of a support, and a toner fixation layer provided on the support. For example, there has been employed an electrophotographic recording material having a plastic support film, and a toner fixation layer provided on a surface of the support film and containing a metal compound and other components. Generally, such a toner fixation layer is formed by admixing a metal compound and other additives with a resin to make a coating liquid and applying the coating liquid onto a support film such that an appropriate coating thickness is attained.

Japanese Patent Application Laid-Open (kokai) No. 2003-43722 discloses that a conventional electrophotographic recording material having such a toner fixation layer for receiving images is required to have a surface resistivity of the toner fixation layer falling within a range of 1×10⁹ to 1×10¹⁴ Ω in order to attain excellent toner image transferrability and high image density. However, even though the surface resistivity of the toner fixation layer is controlled to fall within the aforementioned range, requirements such as toner fixability, prevention of toner dispersion, prevention of unevenness in toner images, and image density are difficult to satisfy simultaneously. Thus, there is demand for a further improved recording material satisfying all these requirements, and also feeding performance of the recording material in a printer must be further improved from the viewpoint of practical use.

In general, synthetic resins are readily charged with static electricity and, particular in electrophotographic printing method, a support film made of synthetic resin is readily charged with static electricity during printing. As a result, printed-out sheets stick together and cannot be arranged properly, resulting in problematic mal-operability. In addition, since such a recording material is usually subjected to high-temperature conditions in an electrophotographic-type printer, the resin for forming the recording material is limited to resin having high heat resistance.

### SUMMARY OF THE INVENTION

The present inventor has attempted to form various electrophotographic toner fixation layers in order to solve the aforementioned problems, as well as to attain excellent toner image quality, high image transferrability, and high image density. In the above study, the inventor focused on the conductive tin oxide compound to be incorporated into a toner fixation layer, and also investigated a wide variety of resins for forming the toner fixation layer. As a result, the inventor has found that the aforementioned problems can be effectively solved by employing stannic oxide as a tin oxide compound and controlling the ratio of volume resistivity (Ω·cm) of a recording material to surface resistivity (Ω) of a toner fixation layer containing stannic oxide so as to fall within a specific range, the correlation between these resistivity values being an important factor from the standpoint of electric technology.

Thus, an object of the present invention is to provide an electrophotographic recording material which attains improved levels of toner fixability, prevention of toner dispersion, prevention of unevenness in toner images, and excellent image density, as well as excellent toner image quality, high image transferrability, and high image density.

Another object of the invention is to provide an electrophotographic recording material which exhibits improved sheet feeding performance in a printer. Other objects and technical features of the invention will be readily appreciated with reference to the following detailed description.

Accordingly, the present invention provides an electrophotographic recording material comprising a plastic support film, and a toner fixation layer provided on at least one surface of the plastic support film and containing a tin oxide, wherein the tin oxide is stannic oxide; the toner fixation layer has a surface resistivity A (Ω) of 1×10⁹ to 1×10¹⁴ Ωas measured at 23° C. and a relative humidity of 50%; and the recording material has a volume resistivity B (Ω·cm) as measured at 23° C. and a relative humidity of 50% which is cotrolled so that a ratio (B/A) falls within a range of 1×10² to 1×10⁵.

Preferably, the stannic oxide is amorphous stannic oxide; the toner fixation layer has a surface resistivity A (Ω) of 1×10¹⁰ to 1×10¹³ Ω; the recording material has a volume resistivity B (Ω·cm) of 1×10¹³ to 1×10¹⁶ Ω·cm as measured at 23° C. and a relative humidity of 50%; and the ratio (B/A) is controlled to fall within a range of 1×10² to 1×10⁵; the amount of stannic oxide falls within a range of 20 to 50 mass % based on the solid content of the toner fixation layer and the mass of the toner fixation layer falls within a range of 0.1 to 1.0 g/m²; the toner fixation layer is formed on the support film through an anchor layer; the toner fixation layer further contains a lubricant.

### DETAILED DESCRIPTION OF PREFERRED EMBODIMENTS

The plastic material used for the support film of the electrophotographic recording material of the present invention is not specifically limited, and there may be employed general synthetic resins such as polyesters, including polyethylene terephthalate, cellulose esters, polysulfone, polyphenylene oxide, polyimide, polycarbonate, polyamide, vinyl chloride resin, polypropylene, and polystyrene. When transparency or heat resistance of the recording material is required, these resins are appropriately selected in accordance with the required properties. An electrophotographic recording material having high transparency is preferably applicable to a specific printing material for making a sticker having an image portion and the remaining transparent portion for applying onto window panes.

In the case where the recording material is used under high temperature conditions, a support film is made from a high-heat-resistance material such as polyester. In the case of a colored or opaque support film, the film is produced by adding an organic colorant or inorganic micropowder such as silica powder or calcium carbonate powder to a base resin. Furthermore, an opaque plastic foam film having fine air bubbles or pores in the film may also be employed. The production method and the shape and distribution state of air bubbles and pores are not specifically limited, and such plastic foam film may be produced through drawing a base film containing an inorganic powder such as calcium carbonate powder to form air bubbles around the powder particles (i.e., formation of micro-void film) or through heating a base material containing a foaming agent. Examples of the plastic foam film include Toyopearl Film P4258 (trade name, product of Toyobo Co., Ltd.) and Yupo FPG 80 (trade name, product of Yupo Corporation). Alternatively, the support film of the recording material of the present invention may be formed of synthetic paper.

In recent years, adverse effects of plastics on the global environment have been extensively investigated, and biodegradable plastic materials have become a matter of increasing interest. In general, biodegradable plastic material has low combustion energy, does not generate toxic gas, and is gradually degraded (metabolized) by microorganisms, thereby eventually forming water and carbon dioxide in the natural environment. In other words, biodegradable plastic material is an environment-friendly material. The support film employed in the electrophotographic recording material of the present invention may be formed from such a biodegradable plastic material. Examples of typical biodegradable plastic materials employed in the present invention include poly(lactic acid), a starch and modified poly(vinyl alcohol) mixture, a poly(butylene succinate/adipate) copolymer, polycaprolactone, and a poly(hydroxybutylate/valerate) copolymer. Of these, poly(lactic acid) is particularly preferred, from the standpoint of degradation rate and film strength. Other plastic materials may also be added to the biodegradable plastic materials in order to enhance properties such as film strength, in an amount not impair biodegradability.

The support film employed in the present invention may have a single-layer structure or a multilayer stacked structure. The multilayer-structure plastic film may be formed through any of known methods, such as laminating films by the mediation of adhesive; co-extrusion in which different materials are extruded into film by means of a plurality of extruders, thereby forming a laminate film; and extrusion-lamination in which one film is extruded, through an extruder, directly onto another film, thereby forming a laminate film.

The surface of the support film may be coarsened through a treatment such as an oxidation method an unevenly patterning method, etc. so as to enhance adhesion and wetting with respect to the toner fixation layer, thereby attaining high bonding strength. Examples of typical techniques of oxidation method include corona discharge treatment and hot air blow treatment, and examples of typical techniques of unevenly patterning method include sand blast and solvent treatment. The surface treatment is appropriately selected in accordance with the type of the support film. Generally, corona discharge treatment is preferably employed, from the viewpoint of effect and operability. Alternatively, any known adhesion facilitating treatment may also be performed.

The toner fixation layer containing stannic oxide which is formed on a surface of the aforementioned plastic support film may be provided on the film through direct coating of a coating liquid. Alternatively, an anchor coat layer may be provided on the support film so as to enhance bonding strength with respect to the toner fixation layer. The anchor coat layer is formed from a substance which has excellent affinity or compatibility to both of the support film and the toner fixation layer, and the type of the substance is selected in accordance with the type of the resin forming the support film and the type of the resin forming the toner fixation layer. The type of the substance may be selected empirically and readily by those skilled in the art. Generally, the anchor coat layer is formed by dissolving a selected resin component(s) in an organic solvent which enables dissolution of the component(s) to form a coating solution, or dispersing the component(s) to form a coating dispersion; applying the solution or dispersion to the surface of the support film; and drying. The formed layer generally assumes a comparatively thin layer. The coating method for forming the coating layer is not specifically limited, and any of various known techniques, such as reverse roll coating, air knife coating, gravure coating, blade coating, comma coating, and wire bar coating, may be employed. Through drying and solvent removal of the applied anchor coating liquid, a coating layer tightly bonded to the surface of the support film can be formed.

As described above, the toner fixation layer of the electrophotographic recording material of the present invention is formed on the support film directly or through an anchor layer. Examples of binders for forming the toner fixation layer include polyester resin, urethane base resin, acrylic resin, poly(vinyl alcohol), poly(vinyl butyral), gelatin, poly(vinyl acetal), carboxymethyl cellulose, polyvinylpyrrolidone, chlorinated polypropylene, poly(vinyl versatate) resin, styrene-acrylic copolymer, ethylene-vinyl acetate copolymer, and styrene-butadiene rubber. These resins may be used singly or in combination of two or more species. The total amount of these resins is generally 40 to 80 mass %, on the basis of the solid content of the toner fixation layer. When the total amount is 40 mass % or more, the toner fixation layer exhibits high strength, whereas when the amount is less than 80 mass %, high-quality printing images can be obtained. The total amount is preferably 50 to 70 mass %.

To the toner fixation layer of the present invention, stannic oxide serving as an electrically conductive microparticle substance is added, and the microparticles are dispersed in the toner fixation layer. The amount of stannic oxide falls within a range which is generally employed in the art, for example, 20 to 50 mass % based on the solid content of the toner fixation layer. When the amount is 20 mass % or more, excellent antistatic performance is attained, and when the amount is less than 50 mass %, the toner fixation layer has high strength. The preferred amount in practice is 30 to 40 mass %. When stannic oxide Is incorporated in an amount falling within the aforementioned range, surface resistivity of the toner fixation layer can be maintained at an appropriate value, which is remarkably advantageous.

Among stannic oxide species, amorphous stannic oxide is particularly preferably employed in the toner fixation layer of the recording material of the present invention. In many cases, a tin compound doped with antimony or another dopant is incorporated into the toner fixation layer. But in the production of a coating liquid for forming the toner fixation layer, antimony is prone to dissociate from the tin compound. When antimony dissociate from the tin compound, the antistatic effect is degraded, and image quality and feeding performance are readily affected. However, the present inventor has found that, when amorphous stannic oxide is employed, antistatic performance can be attained without doping with antimony or another dopant. Thus, when amorphous stannic oxide is employed in the present invention, degradation in antistatic performance can be prevented, and consistent image quality and feeding performance can be attained, which is preferred.

The mass of the toner fixation layer is preferably 0.1 to 1.0 g/m², with 0.2 to 0.6 g/m² being particularly preferred, from the viewpoint of layer strength and image quality. As used herein, the term “mass” refers to the mass of the toner fixation layer itself, not to the mass of a coating liquid for forming the layer through coating.

In order to attain excellent transferrability of toner images and excellent image density, it is important that the toner fixation layer has a surface resistivity A (Ω) of 1×10⁹ to 1×10¹⁴ Ω as measured at 23° C. and a relative humidity of 50%. In this connection, it is also important that the recording material has a volume resistivity B (Ω·cm) at 23° C. and a relative humidity of 50% controlled so that the ratio (B/A) falls within a range of 1×10² to 1×10⁵. In addition, the aforementioned toner fixation layer preferably has a surface resistivity A (Ω) of 1×10¹⁰ to 1×10¹³ Ω, and the recording material preferably has a volume resistivity B (Ω·cm) of 1×10¹³ to 1×10¹⁶ Ω·cm, and the ratio (B/A) is controlled to fall within above range. When the ratio (B/A) falls outside the above range, improvement of toner fixability, prevention of toner dispersion, prevention of unevenness in toner images, and high image density cannot be attained, which is not preferred. Thus, the ratio (B/A) preferably falls within a range of 5×10² to 5×10³. The ratio (B/A) may be regulated by adjusting either surface resistivity A (Ω) or volume resistivity B (Ω·cm), or by adjusting both.

In the control of the ratio, surface resistivity may be regulated by adjusting the mass of the toner fixation layer, which is a remarkably practical method. In general, when the mass of the toner fixation layer is increased by thickening the toner fixation layer, surface resistivity A (Ω) of the toner fixation layer decreases. Simultaneously, volume resistivity B (Ω·cm) of the electrophotographic recording material also decreases. However, since the decrease in surface resistivity A is greater than that in volume resistivity B, the (B/A) value increases. Thus, when merely the thickness of the toner fixation layer is regulated, the (B/A) value can be controlled to fall within a desired range. In consideration of operability and practical application, the (B/A) value can be effectively controlled through this method. The thickness of the layer can be effectively controlled so long as the toner fixation layer has the aforementioned preferred range of the mass.

Other applicable controlling methods of the (B/A) value are selecting the type and amount of the various additives for the toner fixation layer; selecting the pore volume of air bubbles in the support film; and controlling the void volume of the toner fixation layer. For example, by adding silica to the toner fixation layer and controlling the amount of silica, surface resistivity of the toner fixation layer and volume resistivity of the recording material can be decreased. The amount of silica for reducing the resistivity values may be comparatively small; for example, about 0.1 to 3 mass % on the basis of the solid content of the toner fixation layer, whereby excellent feeding performance and high image quality can be obtained. The amount of silica employed is preferably 0.5 to 1.5 mass %.

Alternatively, the (B/A) value may be controlled by selecting the properties of the resin, inter alia, selecting in consideration of the types of hydrophilic groups and hydrophobic groups included in the resin molecule and the balance therebetween. The aforementioned controlling methods and techniques involved in the methods may be empirically and readily selected by a person skilled in the art.

The conditions under which intrinsic resistivity values of the electrophotographic recording material of the present invention are determined include a temperature of 23° C. and a relative humidity of 50%. This criteria for selecting the conditions are based on requirement of specifying the determination conditions and preference of conditions for obtaining remarkably consistent measures.

The toner fixation layer may further contain a lubricant. The lubricant incorporated into the toner fixation layer provides lubrication on the surface of the toner fixation layer through protrusion of a portion thereof to the surface, and any of known lubricants may be employed. Among them, polyolefin wax such as polyethylene wax is preferred, from the viewpoint of stability of the coating solution for forming the toner fixation layer and a smaller effect on toner fixation. Polyolefin wax assuming the form of virtually complete spherical particles serves as an effective lubricant which has these effect largely. More preferably, the lubricant has a particle size, as measured through the Coulter counter method, of 1.0 to 15.0 μm, a Vicat softening point, as measured in accordance with ASTM D1525-70, of 100 to 150° C., and a lowest film formation temperature of 70 to 150° C. When the particle size is smaller than 1.0 μm, the lubricant is buried in the toner fixation layer, thereby failing to attain lubrication effect in some cases, whereas when the particle size is in excess of 15.0 μm, the toner fixation layer has a surface having increased roughness, resulting in deterioration of toner fixation and printability. Furthermore preferably, the lubricant has a particle size of 2.0 to 12.0 μm. When the Vicat softening point is lower than 100° C., the toner fixation layer is melt-adhered to a fixation roller at high temperature, causing feeding failure, whereas when the Vicat softening point is higher than 150° C., toner fixation is deteriorated, resulting in impairment of printability in some cases. Thus, more preferably the Vicat softening point is 110 to 140° C.

A variety of additives such as a surfactant, a defoaming agent, an antistatic agent, a UV-absorber, a fluorescence brightener, a preservative, a pigment dispersant, and a thickener may be incorporated into the toner fixation layer in accordance with needs, in an extent not deriver from the scope of the present invention. These additives may be incorporated into a coating solution for forming the toner fixation layer. Through incorporation of these additives, surface resistivity of the toner fixation layer and volume resistivity of the electrophotographic recording material can be modified. Thus, this technique can also be employed for controlling intrinsic resistivity values.

The electrophotographic recording material of the present invention has another advantage. That is to say, when a support film having high transparency is used, a highly transparent electrophotographic recording material having a haze of 1.0 to 3.0% can be readily provided. Needless to say, depending on applications, a low-transparency electrophotographic recording material can be produced by use of a low-transparency support film.

The electrophotographic recording material of the present invention includes a support film, a toner fixation layer, and an optional anchor coat layer. In addition to these layers, a UV-absorbing layer or a layer for preventing curling may be provided in accordance with needs. In the electrophotographic recording material of the present invention, a toner fixation layer is provided on at least one surface of a support film. For example, the recording material which is provided with a toner fixation layer on each surface of an opaque plastic support film and both of the toner fixation layers are imaged or printed can be preferably employed for producing POP posters to be hung on the ceiling of a store.

The method for forming the toner fixation layer is not specifically limited and the layer is generally formed by use of a coating liquid therefor. The coating method is not specifically limited and any of various known techniques such as reverse roll coating, air knife coating, gravure coating, blade coating, comma coating, and wire bar coating may be employed.

The electrophotographic recording material of the present invention is remarkably advantageous in that low charge amount and high percent electrostatic attenuation, which are key factors of reducing toner dispersion and unevenness of printed images and enhancing feeding performance during printing, can be readily attained.

### EXAMPLES

The present invention will next be described in more detail by way of example, which however shall never limit the present invention thereto.

In every example, reverse roll coating was employed as a coating method of coating liquid.

### Example 1

A transparent polyester film having a thickness of 100 μm (trade name: A8300, product of Toyobo Co., Ltd.) was used as a support film. A coating liquid for forming a toner fixation layer was prepared by uniformly mixing the below-described components at the below-specified proportions (by mass). A recording material was prepared by use of the coating liquid.

*Stannic oxide (trade name: EPS-12A, product of Yamanaka & Co., Ltd, solid content 12 mass %, amorphous and undoped,)—37.00 parts by mass

*Urethane resin (trade name: Adeka Bontighter HUX-401, product of Asahi Denka Kogyo Co., LTD, solid content 37 mass %,)—19.37 parts by mass

*Defoaming agent (trade name: SN-Defoamer 480, product of San Nopco Ltd., solid content 100 mass %,)—0.03 parts by mass

*Silica (trade name: GASIL 200DF, product of Wilbur-Ellis Co., Ltd., solid content 100 mass %,)—0.12 parts by mass

*Surfactant (trade name: Olfine EXP-4036, product of Nisshin Chemical Industry Co., Ltd., solid content 80 mass %,)—0.13 parts by mass

*Water—108.62 parts by mass

The aforementioned coating liquid for forming a toner fixation layer was applied to one surface of the support film so as to adjust the mass after drying of the formed coating layer to 0.4 g/m². The thus-coated support film was dried, to thereby produce an electrophotographic recording material having a toner fixation layer. The toner fixation layer of the thus-produced recording material was found to have a surface resistivity of 7.8×10¹¹ Ω, and the recording material was found to have a volume resistivity of 7.2×10¹⁴ Ω·cm. Thus, B/A value was 9.2×10². The recording material was found to have a charge amount of 3.45 mV and a percent electrostatic attenuation of 89.86%.

### Example 2

The procedure in Example 1 was repeated, except that the toner fixation layer was formed on the support film through an anchor layer which was formed by coating a coating liquid prepared by uniformly mixing the below-described components at the below-specified proportions, to thereby produce an electrophotographic recording material.

*Water dispersed co-polyester (trade name: VYLONAL MD-1500, product of Toyobo CO., LTD, solid content 30 mass %, Tg of the solid 77° C.)—25.50 parts by mass

*Water—165.75 parts by mass

The toner fixation layer of the thus-produced recording material was found to have a surface resistivity of 1.3×10¹¹ Ω, and the recording material was found to have a volume resistivity of 2.1×10¹⁵ Ω·cm. Thus, B/A value was 1.6×10⁴. The recording material was found to have a charge amount of 3.40 mV and a percent electrostatic attenuation of 91.18%.

### Example 3

The procedure in Example 1 was repeated, except that a coating liquid for forming a toner fixation layer prepared by uniformly mixing the below-described components at the below-specified proportions was used, instead of the coating liquid for forming a toner fixation layer in Example 1, to thereby produce an electrophotographic recording material.

*Stannic oxide (trade name: EPS-12A, product of Yamanaka & Co., Ltd, solid content 12 mass %, amorphous and undoped)—21.25 parts by mass

*Urethane resin (trade name: Adeka Bontighter HUX-401, product of Asahi Denka Kogyo Co., LTD, solid content 37 mass %)—19.37 parts by mass

*Lubricant; low molecular polyester [trade name: CHEMIPEARL W-310, product of Mitsui Chemicals Inc., solid content 40 mass %, virtually complete spherical particles, particle size (as measured through the Coulter counter method) 9.5 μm, Vicat softening point 132° C., lowest film formation temperature 115° C.]—0.30 parts by mass

*Water—108.62 parts by mass

The toner fixation layer of the thus-produced recording material was found to have a surface resistivity of 1.1×10¹³ Ω, and the recording material was found to have a volume resistivity of 2.1×10¹⁵ Ω·cm. Thus, B/A value was 1.9×10². The recording material was found to have a charge amount of 1.85 mV and a percent electrostatic attenuation of 84.05%.

### Comparative Example 1

The procedure of Example 1 was repeated, except that 25.50 parts by mass of a urethane resin (trade name: Adeka Bontighter HUX-232, product of Asahi Denka Co., LTD, solid content 30 mass %,) was used instead of 19.37 parts by mass of Adeka Bontighter HUX-401 employed for forming the toner fixation layer in Example 1, to thereby produce an electrophotographic recording material. The toner fixation layer of the thus-produced recording material was found to have a surface resistivity of 3.9×10¹³ Ω, and the recording material was found to have a volume resistivity of 2.1×10¹⁵ Ω·cm. Thus, B/A value was 5.4×10¹. The recording material was found to have a charge amount of 5.2 mV and a percent electrostatic attenuation of 21.15%.

The above surface resistivity, volume resistivity, charge amount, and percent electrostatic attenuation were measured and calculated through the following procedures.

Surface resistivity (Ω): Resistance of the surface of the toner fixation layer was measured by means of a High-resistancemeter HP 4339B (trade name, product of Yokogawa-Hewlett-Packard Ltd.), in an atmosphere of 23° C. and 50% RH, in accordance with JIS K6911.

Volume resistivity (Ω·cm): Resistance of each test piece was measured by means of a High-resistancemeter HP 4339B (trade name, product of Yokogawa-Hewlett-Packard Ltd.), in an atmosphere of 23° C. and 50% RH. The test piece was placed in a concentric electrode 16008B (trade name, product of Yokogawa-Hewlett-Packard Ltd., inner electrode diameter: 50 mm, outer electrode inner diameter: 70 mm, outer diameter: 80 mm, guard electrode diameter: 80 mm), and a voltage of 100 V was applied to the electrode. One minute after voltage application, resistance was measured in accordance with JIS K6911.

Charge amount (kV): A surface of each test piece (40 mm×40 mm) was charged at 10 kV for one minute. Immediately after completion of charging, charge amount A (kV) of the test piece was measured by means of a STATIC HONESTMETER (trade name, product of Shishido Electrostatic Ltd.).

Percent electrostatic attenuation (%): One minute after completion of charging, charge amount B (kV) of the test piece was measured, and percent electrostatic attenuation one minute after charging was calculated on the basis of the following equation:
Percent electrostatic attenuation (1 min after charging)=[(A−B)/A]×100(%)

The recording material samples produced in Example 1 and Comparative Example 1 were evaluated in terms of haze and bonding strength of the toner fixation layer, which were measured and evaluated through the following procedure.

Haze (%): Measured by means of a DIRECT READING HAZEMETER (trade name, product of Toyo Seiki Seisaku-syo, LTD.)

Bonding strength of toner fixation layer: A cut piece (length: 10 cm) of cellophane adhesive tape (trade name: CT405A-18, product of Nichiban Co., Ltd.) was affixed on a toner fixation layer by means of a press roller at a load of 2 kg through three reciprocating rolling steps. The thus-affixed adhesive piece was peeled at a peeling angle of 135°, and the status of the peeled piece was evaluated on the basis of the following ratings.

◯ . . . Toner fixation layer transferred adhering to 30% or less the area of the cellophane adhesive piece

Δ . . . Toner fixation layer transferred adhering to more than 30% and not more than 60% the area of the cellophane adhesive piece

X . . . Toner fixation layer transferred adhering to more than 60% the area of the cellophane adhesive piece

The recording material samples produced in Example 1 and Comparative Example 1 were printed to form images by means of a commercial full-color laser printer (trade name: SPEEDIA N5II, product of Casio Computer Co., Ltd.) with a genuine toner. Image density, toner dispersion, and feeding were determined and evaluated through the following procedures. Specifically, image sample (1) consisted of solid image potions at a percent dot area of 100% (Illustrator 8.0), the image portions being cyan, magenta, yellow, and black. The printer was operated in Peach 1 mode. Image sample (2) was a full-color solid image, and the printer was operated also in Peach 1 mode.

Image density: Solid images [image (1)] were printed, and reflection density of each image was determined by means of a Macbeth optical densitometer (trade name: RD-918).

Toner dispersion in: Printed images (image (1)) were visually observed, and evaluated on the basis of the following ratings.

◯ . . . Very small amount of toner dispersion,

excellent image quality

Δ . . . Small amount of toner dispersion,

satisfactory image quality in practical use

X . . . Large amount of toner dispersion,

unsatisfactory image quality in practical use

Feeding: Solid image [image (2)] was repeatedly printed 10 times, and feeding of recording material sheets was evaluated on the basis of the following ratings.

◯ . . . No printer jam or sheet stacking occurred

X . . . Printer jam or sheet stacking occurred even in printing of one sheet

The determined values and evaluation results are shown in Table 1.

TABLE 1

| | | Example | | | C. Ex. |
|---|---|---|---|---|---|
| | | 1 | 2 | 3 | 1 |
| Bonding strength of | | ∘ | ∘ | ∘ | ∘ |
| toner fixation layer | | | | | |
| Haze (%) | | 2.3 | 1.9 | 3.2 | 2.0 |
| Image density | Cyan | 1.19 | 1.19 | 1.21 | 1.19 |
| | Magenda | 1.30 | 1.30 | 1.27 | 1.28 |
| | Yellow | 1.24 | 1.23 | 1.24 | 1.25 |
| | Black | 1.38 | 1.37 | 1.39 | 1.37 |

| | | | | |
|---|---|---|---|---|
| Toner dispersion | ∘ | ∘ | ∘ | x |
| Conveyance | ∘ | ∘ | ∘ | x |

### C. Ex.: Comparative Example

The present invention enables to provide an electrophotographic recording material which attains improved levels of toner fixability, prevention of toner dispersion, prevention of unevenness in toner images, and excellent image density, as well as excellent toner image quality, high image transferrability, and high image density. In addition, the invention enables to provide an electrophotographic recording material which exhibits improved sheet feeding performance in a printer and is suitable for practical use.

What is claimed is:

1. An electrophotographic recording material comprising a plastic support film, and a toner fixation layer provided on at least one surface of the plastic support film and containing a tin oxide, wherein the tin oxide is stannic oxide; the toner fixation layer has a surface resistivity A (Ω) of 1×10⁹ to 1×10¹⁴ Ωas measured at 23° C. and a relative humidity of 50%; and the recording material has a volume resistivity B (Ω·cm) as measured at 23° C. and a relative humidity of 50% which is controlled so that a ratio (B/A) falls within a range of 1×10² to 1×10⁵.

2. The electrophotographic recording material as described in claim 1, wherein the stannic oxide is amorphous stannic oxide.

3. The electrophotographic recording material as described in claim 1, wherein the surface resistivity A falls within a range of 1×10¹⁰ to 1×10¹³ Ω, and the recording material has a volume resistivity B falling within a range of 1×10¹³ to 1×10¹⁶ Ω·cm, and the ratio (B/A) is controlled to fall within a range of 1×10² to 1×10⁵.

4. The electrophotographic recording material as described in claim 1, wherein the amount of stannic oxide falls within a range of 20 to 50 mass % based on the solid content of the toner fixation layer and the mass of the toner fixation layer falls within a range of 0.1 to 1.0 g/m².

5. The electrophotographic recording material as described in claim 1, wherein the toner fixation layer is formed on the support film through an anchor layer.

6. The electrophotographic recording material as described in claim 1, wherein the toner fixation layer further contains a lubricant.
